(19) United States
(12) Patent Application Publication
(10) Pub. No.: US 2009/0138848 A1
(43) Pub. Date: May 28, 2009

(54) COMPUTER READABLE RECORDING MEDIUM ON WHICH PROGRAM CONVERTING PROCESS PROGRAM IS RECORDED, PROGRAM CONVERTING METHOD, AND PROGRAM CONVERTING APPARATUS

(75) Inventor: Takao OKUBO, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/273,214

(22) Filed: Nov. 18, 2008

(30) Foreign Application Priority Data
Nov. 22, 2007 (JP) 2007-302378

(51) Int. Cl. G06F 9/44

(52) U.S. Cl. 717/110; 717/127

(57) ABSTRACT

A general-purpose rewriting process (patch process) is provided. In a program code, a command statement execution place and initialization of a character string variable of an argument of the command statement execution place are detected, and a range to be replaced is extracted on the basis of the detected place. In an adding operation of the detected character string, a portion (character string) to be added is extracted, and it is determined whether the portion is a fixed character string invariable) Based on information obtained by determining whether the added portion is invariable, a parameterized prepared command statement may be dynamically formed. In execution of the command statement, original function calling may be replaced with function calling using a prepared command statement. By the patch process, a byte code of a target program is rewritten and executed.

### CROSS-REFERENCE TO RELATED APPLICATIONS

This application is based upon and claims the benefit of priority from the prior Japanese Patent Application No. 2007-302378 filed on Nov. 22, 2007, the entire contents of which are incorporated herein by reference.

### BACKGROUND

1. Field

The embodiments discussed herein are directed to a program converting process.

2. Description of the Related Art

A Web application program developed without any appropriate countermeasure against injection attack may often have vulnerability to SQL injection or OS command injection.

An example of the SQL injection which is one of injection attacks is discussed below.

FIG. 1 illustrates an example configuration of a Web application. When a user operates the Web application through a Web browser 91 on a client machine, data generated on the basis of the operation by the user may be transmitted to a server. On a server program 90, transmission data from the Web browser 91 may be input, a command statement such as an SQL command or an OS command to a shell or the like is composed (S1), and the database or the OS is called by using the command sentence as an argument to execute the process (S2).

FIGS. 2A and 2B illustrate an example of calling of the SQL command in an ID/password authentication process. When an ID (user) and a password (pass) of the user are input by the Web browser 91, an SQL command loaded by using these values as a search condition is composed on a server program 90 and then executed.

The SQL statement illustrated in FIG. 2A acquires data of a combination between a specific ID (user) and a specific password (pass). However, as illustrated in FIG. 2A, when a value such as “OR′A=A′” is input as the pass, in composition of a simple SQL statement, an SQL statement which is syntactically different from an SQL command intended by the program is composed. As illustrated in FIG. 2B, in the SQL statement composed by input data, A=A is always true, and, even if an input to the pass is arbitrary data, an authentication condition is satisfied. As a result, an ID/password authentication process is not performed.

As described above, when such illegal inputting (injection attack) is performed, a syntax of a command statement (SQL statement here) changes, a process which is not intended by the server program 90 is executed, so that various damages such as spoofing, falsification of data, or tapping may be suffered.

FIG. 3 illustrates an example of a vulnerable Java (registered trademark) program which may cause SQL injection. The reasons why the program illustrated in FIG. 3 is potentially harmful include the following:

(a) A calling function (method) The example function Statement.executeQuery( ) is a function in a vulnerable state in which no countermeasure against injection is made at all.

(b) In composition of an SQL statement which is an argument of the function calling, since a value (fixed value) which is originally determined as a value to be input is added without distinction, an SQL statement which is finally completed cannot be determined to be an SQL statement intended by a program.

Furthermore, conventionally as protection against injection attack, a check policy of a message including a parameter on a Web server side may be prepared, it may be determined whether a message including an input value which causes vulnerability is matched with the check policy, and only the matched message is handled to be significant.

For example, in Java, a safe function (PreparedStatement.Query( )) is prepared.

FIG. 4 illustrates a PreparedStatement.

As illustrated in FIG. 4, when the PreparedStatement is used, a fixed prepared statement on a program is prepared by a programmer. In the prepared statement to be prepared, a position on a syntax into which a parameter is inserted is predetermined. When a value to be input to the parameter includes an SQL syntactic element, the value is consistently handled as a parameter. For this reason, as illustrated in FIG. 4, even though a user executes illegal inputting, the entire syntax of the SQL statement does not change.

FIG. 5 illustrates an example of a program using PreparedStatement.

As illustrated in FIG. 5, in value setting for the parameter, an input value is assigned to a determined place. When the program in FIG. 3 is rewritten with the program using the PreparedStatement in FIG. 5, protection against injection attack can be achieved, and a safe program can be obtained.

However, a source code of an existing program using the Statement illustrated in FIG. 3 cannot be rewritten with a source code illustrated in FIG. 5 without a trouble of performing a code rewriting operation, and recompiling and retest of the program are necessary to increase a burden.

Furthermore, rewriting of the program by the PreparedStatement has another problem.

As in a program illustrated in FIG. 6, an SQL statement to be called changes depending on input conditions or the like of a client.

As illustrated in FIG. 6, a conditional statement in an SQL statement changes in length depending on the value of keys.length. In this case, although it is not impossible to prepare prepared statements of PreparedStatement in accordance with the number of patterns dynamically changed in advance. However, a heavy burden is on a user. More specifically, a large number of prepared statements corresponding to the number of patterns must be prepared, rewriting of the code becomes complex, and the maintainability is also deteriorated.

Furthermore, in Java, a general method which changes Statement calling into PreparedStatement calling without changing a source code by replacing a Statement class with another class is known.

However, in the program illustrated in FIG. 6, not only a calling place but also an added portion of a character string are related to replacing. For this reason, even though classes are simply replaced with each other, conventional methods cannot adequately cope with the program.

### SUMMARY

It is an aspect of the embodiments discussed herein to provide a program converting process method, including monitoring execution of a program code; detecting a character string adding place which performs an adding operation of a character string in initialization of a command statement from execution of the program code; when the character string adding place is detected, extracting a portion added by the character string adding place to determine whether the extracted added portion is invariable; adding a character string of the added portion determined to be invariable to a prepared statement prepared as the command sentence to generate a prepared command character string, storing a character string of the added portion except for the added portion determined to be invariable in a parameter storing unit, and setting a parameter representing the added portion to the prepared command character string; detecting a calling place where the command statement is called from execution of the program code; and, when the calling place is detected, acquiring the prepared command character string, inserting corresponding character strings stored in the parameter storing unit into parameters set in the prepared character string, and executing the acquired prepared command character strings as command statements which are arguments of the calling place.

These together with other aspects and advantages which will be subsequently apparent, reside in the details of construction and operation as more fully hereinafter described and claimed, reference being had to the accompanying drawings forming a part hereof wherein like numerals refer to like parts throughout.

### BRIEF DESCRIPTION OF THE DRAWINGS

FIG. 1 illustrates a configuration of a Web application;

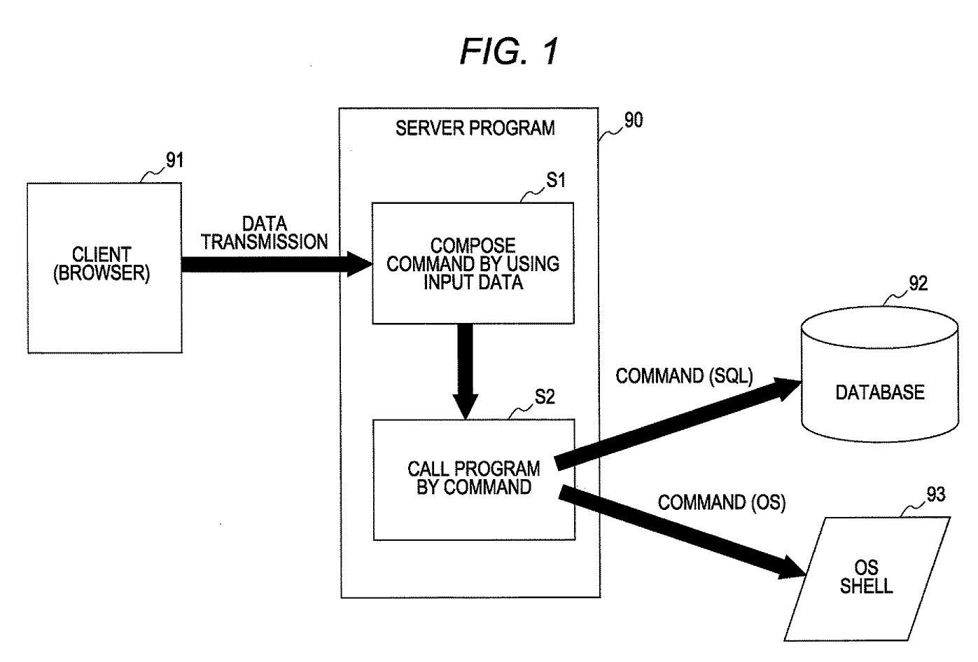

FIGS. 2A and 2B illustrate examples of calling of an SQL command in an ID/password authentication process;

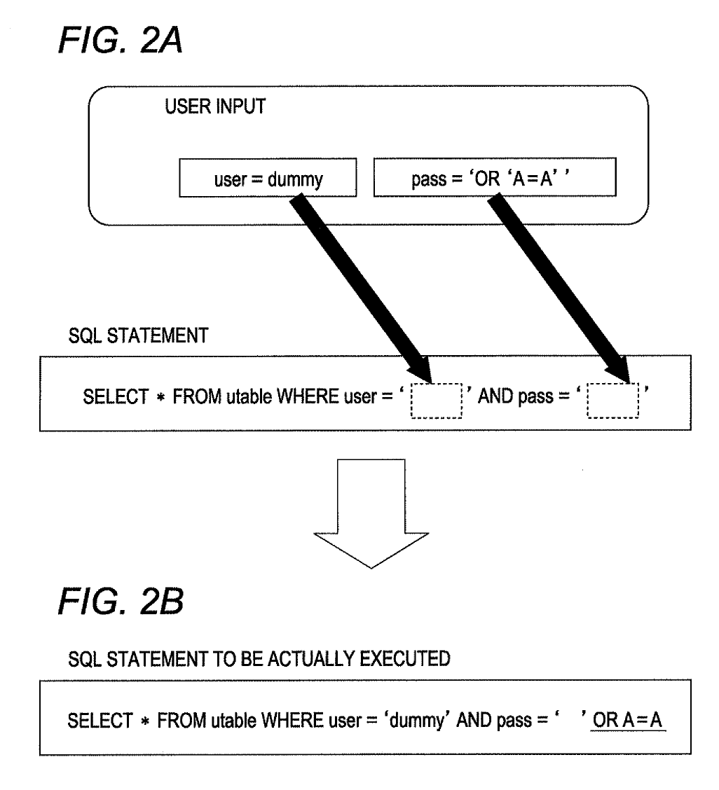

FIG. 3 illustrates an example of a vulnerable program which causes SQL injection;

FIG. 4 illustrates working of PreparedStatement;

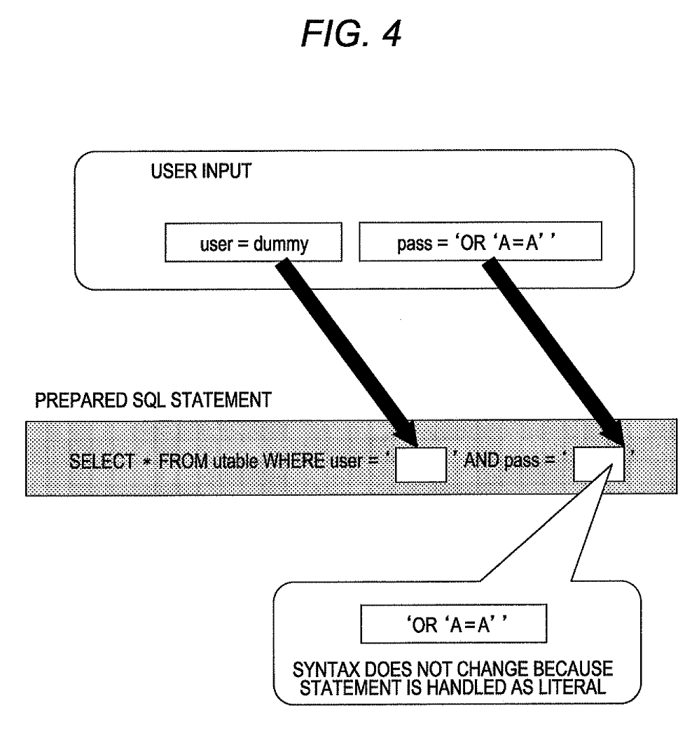

FIG. 5 illustrates an example of a program using PreparedStatement;

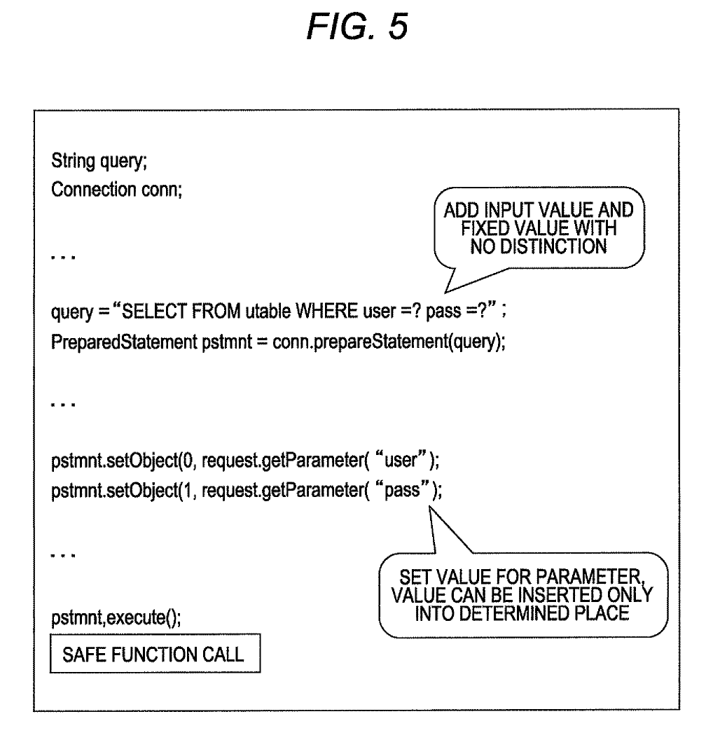

FIG. 6 illustrates an example of a program when an SQL syntax changes depending on input conditions or the like;

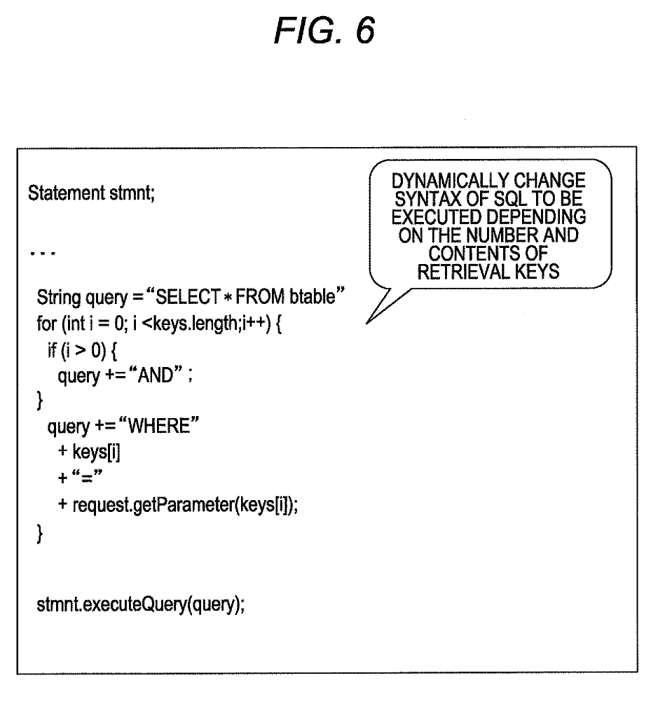

FIG. 7 illustrates an exemplary embodiment;

FIG. 8 illustrates a process in an exemplary embodiment;

FIG. 9 illustrates a process in an exemplary embodiment;

FIG. 10 illustrates an exemplary process according applied to a program.

### DETAILED DESCRIPTION OF THE EMBODIMENTS

An exemplary embodiment is described below when a program is performed as a Java program of computer software.

Features of an exemplary program according to the embodiment are disclosed.

An exemplary general-purpose rewriting process (patch process) is disclosed.

In a program code, a command statement execution place and initialization of a character string variable of an argument of the command statement execution place are detected, and a range to be replaced is extracted on the basis of the detected place.

In an adding operation of the detected character string, a portion (character string) to be added is extracted, and it is determined whether the portion is a fixed character string (invariable).

On the basis of the information obtained by determining whether the added portion is invariable, a parameterized prepared command statement is dynamically formed. In execution of the command statement, original function calling is replaced with function calling using a prepared command statement.

By an exemplary patch process, a byte code of a target program may be rewritten and executed.

A process may include:

(1) On a byte code of a program, a matching pattern which detects the following three execution points may:

(1-a) a point of execution (Statement.execute*) of a command statement,

(1-b) a point of initialization (constructor execution) of a command statement; and

(1-c) a point of a structuring (adding process of character string) of a command statement,

(2) In compiling or loading of a target program, the following codes may be added to a byte code of an original program:

(2-a) a code which detects the execution point in execution of the target;

(2-b) a code which additionally defines a data field in which a character string and a parameter of a prepared statement are accumulated to a type of a command statement variable;

(2-c) a code which, when an execution point is detected, executes the following processes:

(2-c1) an adding process to the command statement variable: structuring of a character string of prepared statement and accumulation of parameters;

(2-c2) a calling statement executing process: by using the accumulated prepared statement and parameters, PreparedStatement is structured, and in place of Statement.execute( ), PreparedStatement.executeQuery( ) is executed.

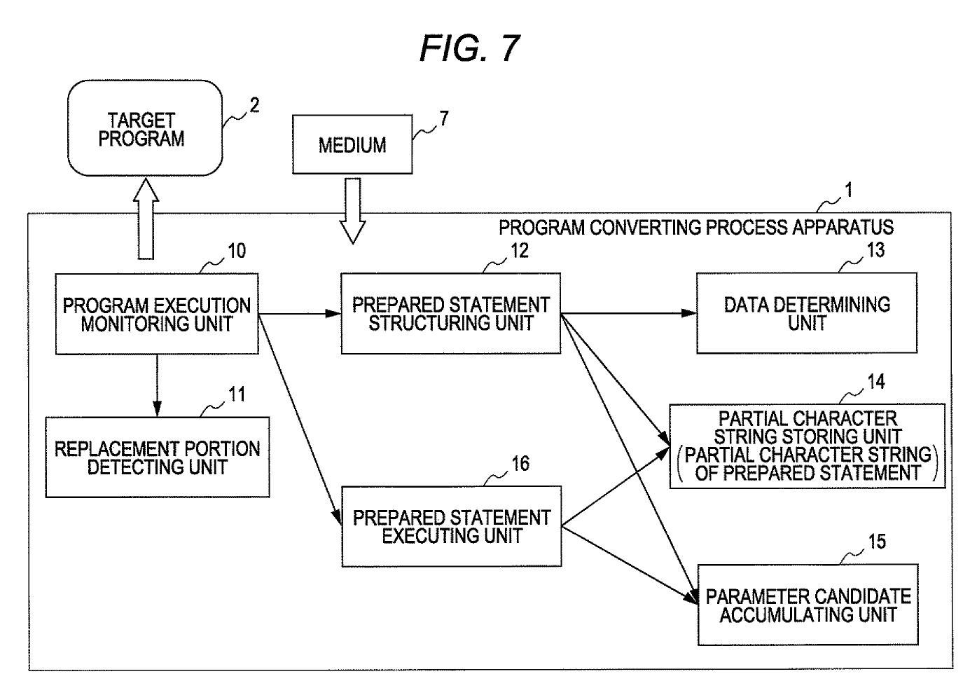

FIG. 7 illustrates an exemplary embodiment.

A program converting process apparatus 1 according to an exemplary embodiment includes a program execution monitoring unit 10, a replacement portion detecting unit 11, a prepared statement composing unit 12 (PreparedStatement structuring unit), a date determining unit 13, a partial character string storing unit 14, a parameter candidate accumulating unit 15, and a prepared statement executing unit (PreparedStatement executing unit) 16. A computer-readable recording medium 700 can be input into the apparatus 1. According to an exemplary embodiment the program execution monitoring unit may be performed as a computer program.

The program execution monitoring unit 10 may be a processing unit which monitors execution of a target program 2, detects a specific execution point, acquires data, or executes a process of the prepared statement structuring unit (PreparedStatement structuring unit) 12 or the prepared statement executing unit (PreparedStatement executing unit) 16. As the specific execution point, a point (1-a) of execution (Statement.execute*) of a command statement is detected.

The replacement portion detecting unit 11 may be processing unit which detects a specific execution point in the target program 2. The replacement portion detecting unit 11 detects a point (1-b) of initialization (constructor execution) of a command statement and a point (1-c) of structuring (adding process of a character string) of the command statement, and specifies a range replaced with a prepared SQL statement.

The prepared statement structuring unit (PreparedStatement structuring unit) 12 is a processing unit which structures a prepared SQL statement (PreparedStatement).

The data determining unit 13 is a processing unit which determines whether data added to the SQL statement is invariable (a fixed character string).

The partial character string storing unit (partial character string of PreparedStatement) 14 is a data field which stores PreparedStatement (prepared statement) during the structuring process.

The parameter candidate accumulating unit (parameter list) 15 is a data field which stores a parameter candidate used in PreparedStatement calling. In the parameter list 15, parameters set in the parameter unit of a prepared statement are sequentially held.

The prepared statement executing unit (PreparedStatement executing unit) 16 is a processing unit which, on the basis of the prepared statement stored in the partial character string 14 of PreparedStatement and the parameters stored in the parameter list 15, executes calling (executeQuery( )) by PreparedStatement.

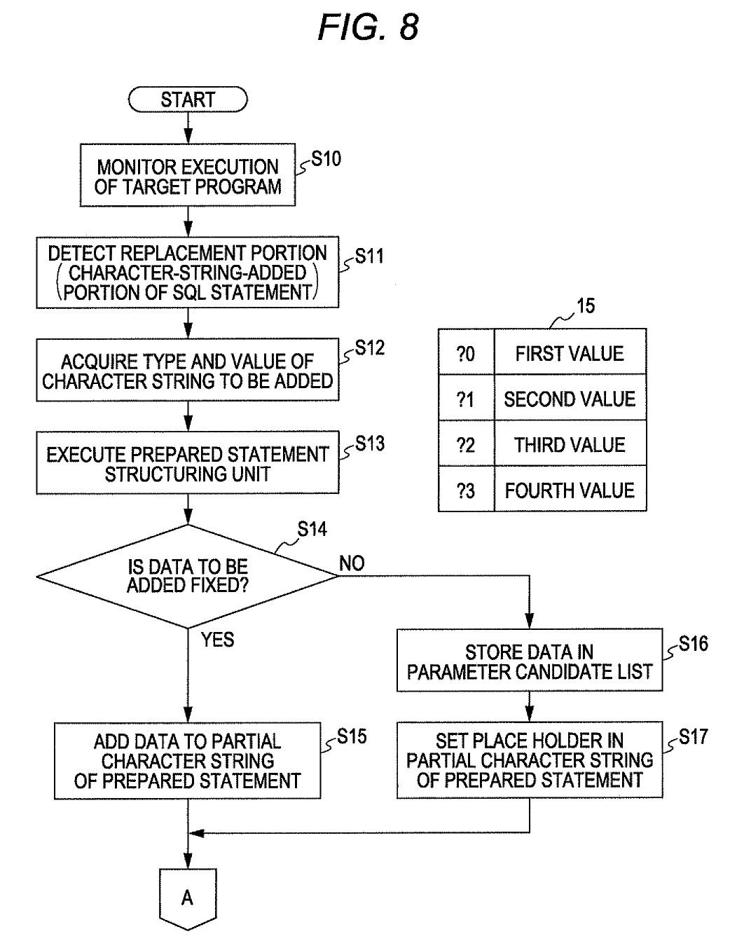

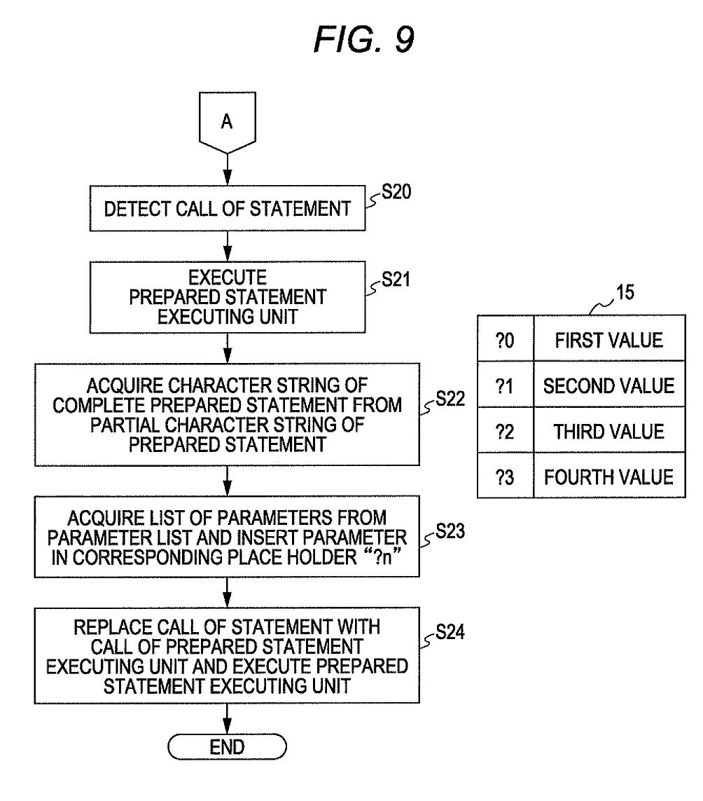

FIGS. 8 and 9 illustrate a process in an exemplary embodiment.

Operation S10: When the target program 2 is executed, the program execution monitoring unit 10 monitors execution of the target program 2.

Operation S11: The replacement portion detecting unit 11 detects a place (character string adding place) to which a character string of an SQL statement of the target program 2 is added as an execution point.

Operation S12: the program execution monitoring unit 10 acquires a type and a value of a character string to be added from a character string adding place.

Operation S13: Data obtained in operation S12 is given to the prepared statement structuring unit 12 and executed.

Operation S14: In the prepared statement structuring unit 12, by using the date determining unit 13, it is determined whether data to be added is fixed.

Operation S15: When it is determined that the data added by the date determining unit 13 is fixed (invariable) (YES in operation S14), the prepared statement structuring unit 12 adds the data to the partial character string 14 of PreparedStatement.

Operation S16: When it is determined that the data added by the date determining unit 13 is not fixed (parameter) (NO in operation S14), the prepared statement structuring unit 12 adds the data to the parameter candidate accumulating unit 15.

Operation S17: Furthermore, the prepared statement structuring unit 12 sets a place holder (character “?n” representing a position where a parameter is added in a prepared statement) to the partial character string 14 of PreparedStatement.

Operation S20: The program execution monitoring unit 10 detects calling (executeXXX( )) of a Statement class in execution of the target program 2 by using the replacement portion detecting unit 11.

Operation S21: The program execution monitoring unit 10 executes the prepared statement executing unit 16.

Operation S22: the prepared statement executing unit 16 acquires a completed prepared statement (character string from the partial character string 14 of PreparedStatement.

Operation S23: The prepared statement executing unit 16 acquires a list of parameters from the parameter candidate accumulating unit 15. The prepared statement executing unit 16 inserts a corresponding parameter into a place holder of the prepared statement of PreparedStatement.

Operation S24: Calling of Statement of the target program 2 is replaced with calling by PreparedStatement (prepared statement), and the replaced calling is performed.

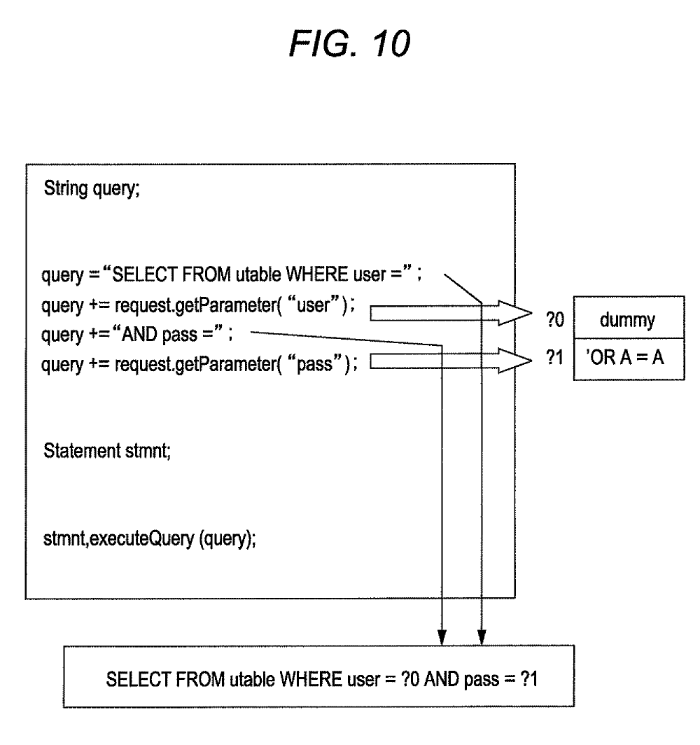

FIG. 10 illustrates an example in which the processes are applied to the program in FIG. 7.

In the character string adding place to the SQL statement of the program, since “query=“SELECT FROM utable WHERE user=”” and “query+=“AND pass=”” are invariable character strings, the character strings are sequentially stored in the partial character string 14 of PreparedStatement.

On the other hand, since “query+=request.get.Parameter(“user”)” and “query+=request.get.pARAMETER(“pass”)” are return values (variable), “dummy” and “′ORA=A” serving as the values (character strings) thereof are stored in the parameter candidate accumulating unit 15 in association with place holders ‘?0’ and ‘?1’.

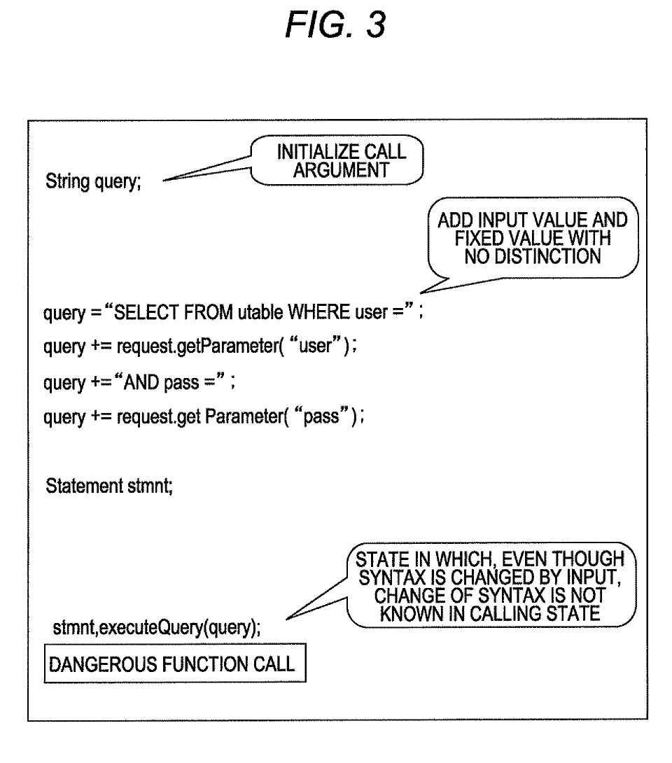

As illustrated in FIG. 3, an input value and a fixed value are not distinctively configured in structuring of an SQL statement. However, according to the present invention, in execution of the target program 2, it is determined whether a character string to be added is fixed. A parameter required to convert into PreparedStatement can be discriminated from other portions.

Furthermore, as another exemplary embodiment, the present invention can be applied with respect to a command statement of OS. Since not only SQL injection but also injection of an OS command have the same structures, the same program converting process can be realized by applying the exemplary embodiment of the present invention.

In an exemplary embodiment, the following processes may be performed.

(1) Structuring Process Similar PreparedStatement as PreparedStatement of SQL Statement

(2) Process of Changing Command Calling into Calling of PreparedStatement Formed in (1).

According to the processes described above, a general purpose rewriting process (patch process) is applied without rewriting a source code of a program, a command statement having vulnerability to injection can be implemented as a safe command statement.

Furthermore, even in a program in which, for example, a conventional fixed prepared statement cannot be easily applied, a condition is dynamically added in execution of the program to make it possible to generate a command statement, and a fixed prepared statement pattern fixed for each condition need not be prepared in advance.

Therefore, protection against from injection attack can be efficiently achieved at low cost.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A computer readable recording medium on which a program to cause a computer to perform a program converting process method is recorded, the method comprising:
monitoring execution of a program code;
detecting a character string adding place which performs an adding operation of a character string in initialization of a command statement from execution of the program code;
when the character string adding place is detected, extracting a portion added by the character string adding place to determine whether the extracted added portion is invariable;
adding a character string of the added portion determined to be invariable to a prepared statement prepared as the command sentence to generate a prepared command character string, storing a character string of the added portion except for the added portion determined to be invariable in a parameter storing unit, and setting a parameter representing the added portion to the prepared command character string;
detecting a calling place where the command statement is called from execution of the program code; and
when the calling place is detected, acquiring the prepared command character string, inserting corresponding character strings stored in the parameter storing unit into parameters set in the prepared character string, and executing the acquired prepared command character strings as command statements which are arguments of the calling place.

2. A program converting process method comprising:
monitoring execution of a program code;
detecting a character string adding place which performs an adding operation of a character string in initialization of a command statement from execution of the program code;
when the character string adding place is detected, extracting a portion added by the character string adding place to determine whether the extracted added portion is invariable;
adding a character string of the added portion determined to be invariable to a prepared statement prepared as the command sentence to generate a prepared command character string, storing a character string of the added portion except for the added portion determined to be invariable in a parameter storing unit, and setting a parameter representing the added portion to the prepared command character string;
detecting a calling place where the command statement is called from execution of the program code; and
when the calling place is detected, acquiring the prepared command character string, inserting corresponding character strings stored in the parameter storing unit into parameters set in the prepared character string, and executing the acquired prepared command character strings as command statements which are arguments of the calling place.

3. A program converting process apparatus comprising:
an execution monitoring unit which monitors execution of a program code;
a corresponding place detecting unit which detects a calling place which calls a command statement or a character string adding place which performs an adding operation of a character string in initialization of a command statement from execution of the program code;
an added portion determining unit which, when the character string adding place is detected, extracting a portion added at the character string adding place to determine whether the extracted added portion is invariable;
a prepared command statement structuring unit which adding a character string of the added portion determined to be invariable to a prepared statement prepared as the command sentence to generate a prepared command character string, stores a character string of the added portion except for the added portion determined to be invariable in a parameter storing unit, and sets a parameter representing the added portion to the prepared command character string;
a parameter storing unit which stores a character string of an added portion except for the added portion determined to be invariable; and
a prepared command statement executing unit which, when the calling place is detected, acquires the prepared command character string, inserts corresponding character strings stored in the parameter storing unit into parameters set in the prepared character string, and executes the acquired prepared command character strings as command statements which are arguments of the calling place.
